(19) United States
(12) Patent Application Publication
(10) Pub. No.: US 2026/0036228 A1
(43) Pub. Date: Feb. 5, 2026

(54) Composite Garden Hose

(71) Applicant: Yuanping WU, Zhejiang (CN)

(72) Inventor: Yuanping WU, Zhejiang (CN)

(21) Appl. No.: 19/357,505

(22) Filed: Oct. 14, 2025

Related U.S. Application Data
(63) Continuation-in-part of application No. 18/407,444, filed on Jan. 9, 2024, now Pat. No. 12,467,567.

(51) Int. Cl. F16L 11/08; F16L 11/12

(52) U.S. Cl. CPC F16L 11/085; F16L 11/122

(57) ABSTRACT

The present disclosure relates to a composite garden hose, comprising a hose body, a first connector and a second connector. The hose body sequentially comprises, from the inside out, a first tubular component made of an elastic material, a second tubular component with a corrugated structure and a third tubular component made of a fabric material, collectively achieving water conveyance, expansion limitation and protective functions.

### CROSS-REFERENCE TO RELATED APPLICATIONS

This application is a continuation-in-part of the application filed on Jan. 9, 2024, titled Composite Garden Hose and Production Process Thereof,” with an application number of 18407444, the content of which is incorporated herein by reference in its entirety.

### TECHNICAL FIELD

The present disclosure relates to the technical field of water hoses, particularly to a composite garden hose.

### BACKGROUND

A garden hose is a pipeline used for conveying water or other liquids, playing a significant role in people's lives. Garden hoses not only provide domestic water, such as drinking water, washing water, and irrigation water, but can also be used for firefighting, heating, cooling, and industrial production. The material, shape, size, and connection methods of garden hoses affect the flow rate, pressure, temperature, and quality of the liquid, necessitating the selection of appropriate garden hoses based on different uses and environments.

However, existing garden hoses on the market generally lack sufficient toughness, are prone to wear and damage during use, and have a short service life. For example, a garden hose disclosed in U.S. Pat. No. 17,521,376 suffers from easy wear and a short service life; similarly, a garden hose disclosed in U.S. Pat. No. 15,638,057 also has issues of low durability and insufficient toughness.

Therefore, to address the above problems, a novel composite garden hose is proposed. This hose offers higher toughness, is lightweight, has a lower wear rate, and is more durable, providing users with a better garden hose experience and a superior choice.

### SUMMARY

The present disclosure provides a composite garden hose to solve the problems mentioned in the background art.

To achieve the above object, the present disclosure adopts the following technical solutions:

A composite garden hose comprises a hose body; wherein the hose body comprises: a first tubular component for conveying a liquid; and a second tubular component continuously formed around the first tubular component to limit expansion of the first tubular component; wherein an outer diameter of the second tubular component is higher than 13 mm and lower than 18 mm; and a third tubular component continuously formed around the second tubular component to protect the first tubular component and the second tubular component; wherein an overall thickness of the third tubular component ranges from 0.2 mm to 1 mm.

The present disclosure provides another technical solution: a composite garden hose, comprising: a hose body; wherein the hose body comprises: a first tubular component, made of any one material from PVC, PE, PP, PEX, PU, nylon or rubber individually, or a combination of two or more of the aforementioned materials; and a second tubular component, made of PP, PE, or PVC materials, with a hardness of the first tubular component being lower than that of the second tubular component; wherein the second tubular component has a corrugated structure and is a corrugated tube as a whole; and a pitch between adjacent crest center points of the second tubular component ranges from 1.5 mm to 4 mm; and a third tubular component, woven from filaments, with an overall thickness ranging from 0.2 mm to 1 mm; wherein the filaments consist of polyester, spandex, nylon, bamboo fiber and rayon.

The present disclosure provides another technical solution: a composite garden hose, comprising: a hose body; wherein the hose body comprises: a second tubular component, made of PP, PE, or PVC materials; wherein the second tubular component has a corrugated structure and is a corrugated tube as a whole; and a pitch between center points of two adjacent crests on a surface of the second tubular component is 1.5 mm to 4 mm; and a third tubular component, woven from filaments, with an overall thickness of 0.2 mm to 1 mm; wherein the filaments consist of polyester, spandex, nylon, bamboo fiber or rayon.

### BRIEF DESCRIPTION OF DRAWINGS

The drawings, which form part of this application, are provided to further illustrate the present disclosure. The illustrative embodiments and the descriptions thereof are intended to explain the present disclosure and do not constitute undue limitations thereof. In the drawings:

FIG. 1 is a schematic diagram of the garden hose;

FIG. 2 is a partial exploded view of the garden hose;

FIG. 3 is another partial exploded view of the garden hose;

FIG. 4 is a schematic diagram of the second connector;

FIG. 5 is a cross-sectional view of the second connector;

FIG. 6 is a first schematic diagram of another embodiment of FIG. 5;

FIG. 7 is a second schematic diagram of another embodiment of FIG. 5;

FIG. 8 is a third schematic diagram of another embodiment of FIG. 5;

FIG. 9 is another cross-sectional view of the second connector;

FIG. 10 is a schematic diagram of the first connector in another embodiment;

FIG. 11 is a schematic diagram of the spiral tube;

FIG. 12 is an enlarged view of section A in FIG. 10;

FIG. 13 is a schematic diagram of another embodiment of a garden hose;

FIG. 14 is a partial exploded view of FIG. 13;

FIG. 15 is a cross-sectional view of FIG. 13;

FIG. 16 is a schematic diagram of the locking assembly;

FIG. 17 is a schematic diagram of another embodiment of FIG. 13;

FIG. 18 is an exploded view of FIG. 17;

FIG. 19 is a schematic diagram of another embodiment of the locking assembly;

FIG. 20 is a schematic diagram of the pitch between center points of two adjacent crests.

Reference signs: Hose Body (1000); First Tubular Component (1001); Second Tubular Component (1002); Third Tubular Component (1003); Spiral Tube (1004); First Connector (2000); Hose Body Connecting Part (2001); Anti-Slip Part (2002); External Threaded Connecting Part (2003); First Slot (2004); Insertion Part (2005); Second Slot (2006); Second Connector (3000); Connection Core (3001); Internal Threaded Sleeve (3002); Sealing Ring (3003); First Flange (3004); Second Flange (3005); Anti-Slip Groove (3006); Metal Clip (4000); Locking assembly (4001); Internal Retaining Ring (4002); External Sleeve (4003); Compressing part (4004); Compressing block (4005); First Threaded Part (4006); Second Threaded Part (4007); First Fixing Block (4008); Second Fixing Block (4009); First Fixing Hole (4010); Second Fixing Hole (4011); Fastener (4012); Grip (5000); Clasp Part (5001); Slot (5002); Internal Thread (5003); External Thread (5004).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

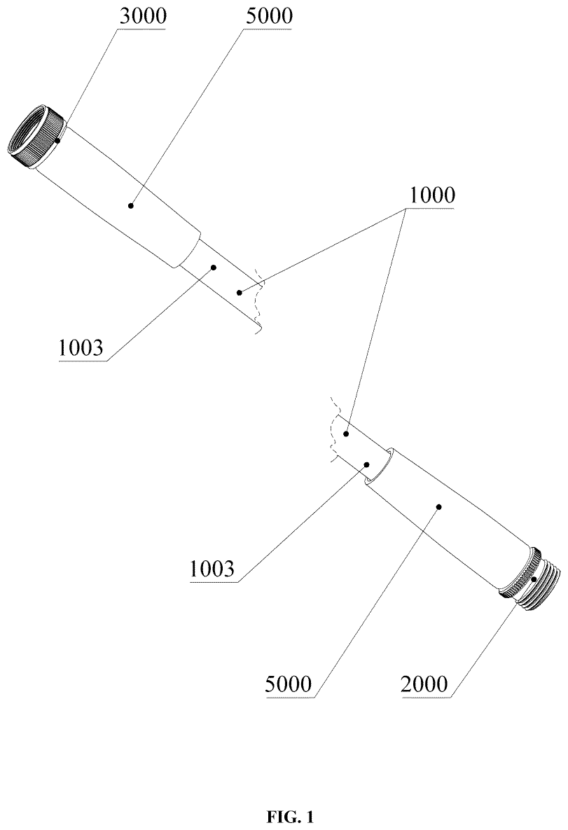

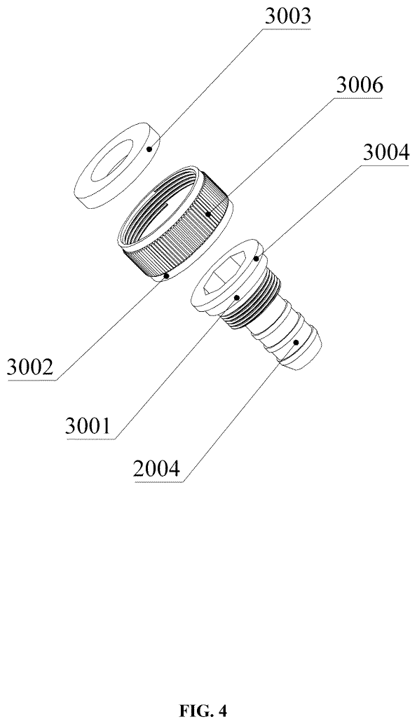

As shown in FIGS. 1 to 4, the present disclosure provides a composite garden hose, which includes a hose body 1000, a first connector 2000 and a second connector 3000.

The hose body 1000 includes a first tubular component 1001, made of an elastic material, for conveying a liquid.

A second tubular component 1002, made of a non-elastic material, has a corrugated structure and is continuously formed around the first tubular component 1001 to limit the expansion of the first tubular component 1001.

A third tubular component 1003, made of a fabric material, is continuously formed around the second tubular component 1002 to protect the first tubular component 1001 and the second tubular component 1002.

The hardness of the first tubular component 1001 is lower than that of the second tubular component 1002.

The first connector 2000 is located at one end of the hose body 1000, and the second connector 3000 is located at the other end. Both ends of the hose body 1000 are tightly connected to the first connector 2000 and the second connector 3000 via metal clips 4000, respectively.

A grip 5000 is sleeved on the third tubular component 1003, forming a detachable connection with the first connector 2000; the grip 50000 forms a detachable connection with the second connector 3000.

The first tubular component 1001 is made of an elastic material. In this embodiment, the elastic material may be polypropylene random copolymer (PPR), polyethylene (PE), ethylene propylene diene monomer (EPDM), polyurethane (PU), or any other suitable elastic material.

The second tubular component 1002 is made of a plastic or rubber material. In this embodiment, it is made of PVC but is not limited to PVC; it may also be PPR, PE, or any other desirable material.

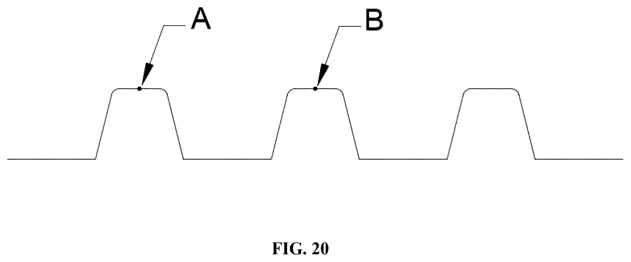

In other embodiments, the crest width on the surface of the second tubular component 1002 ranges from 1.8 mm to 3 mm, and the pitch between the center points of two adjacent crests ranges from 1.5 mm to 4 mm (if the corrugated structure includes a cylindrical surface, the pitch between the center points of two adjacent crests is 1.5 mm to 4 mm, specifically referring to the linear distance between point A and point B in FIG. 20).

In other embodiments, the hose body 1000 may consist of the second tubular component 1002 and the third tubular component 1003.

In this embodiment, the third tubular component 1003 is made of a textile material, which can be polyester fabric, cotton fabric, fiberglass fabric, carbon fiber fabric, or any other desired fabric material. In other embodiments (not shown), the third tubular component is not limited to textile materials and can also be made of plastic, metal, silicone, or any other desired material.

In other embodiments, the third tubular component 1003 is primarily woven from filaments, which mainly consist of polyester or polyester blends.

In other embodiments, when the filaments are spun, the required spindle count is 32, 48, 72, or 96 spindles. Among these, 48 spindles are the most preferred for spinning, followed by 96 spindles, and lastly 32 spindles.

In this embodiment, the hardness of the first tubular component 1001 is lower than that of the second tubular component 1002. In other embodiments, the hardness of the first tubular component 1001 is not limited to being lower than that of the second tubular component 1002 and can also be equal to or higher than that of the second tubular component 1002.

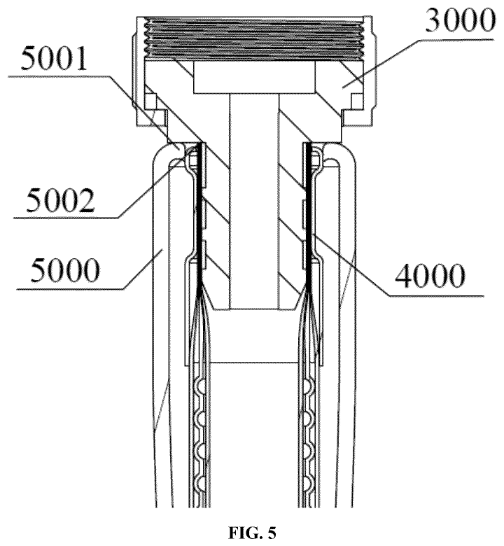

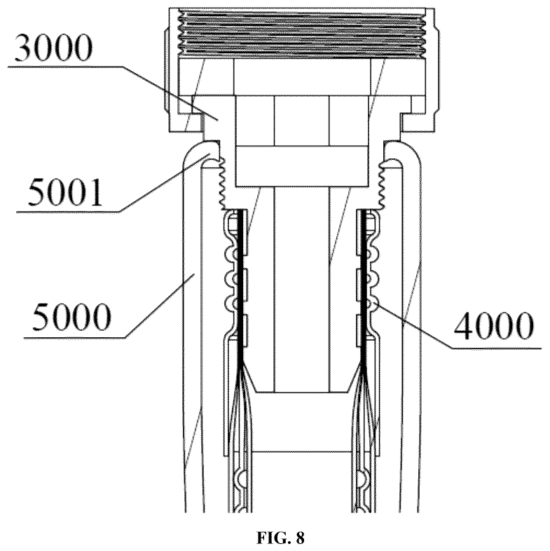

As shown in FIGS. 5 to 8, in this embodiment, the metal clip 4000 is machine-pressed into a gourd or cylindrical shape. In other embodiments (not shown), it can also be trapezoidal, oval, triangular, or any other desired geometric shape. In other embodiments, it is not limited to machine pressing and can also be formed by turning, milling, drilling, casting, or any other desired processing method.

In this embodiment, both ends of the hose body 1000 are tightly connected to the first connector 2000 and the second connector 3000 by metal clips 4000. In other embodiments (not shown), the ends of the hose body are not limited to being connected to the first connector 2000 and the second connector 3000 by metal clips, and can also configured as plastic, silicone, or any other desired materials, or employ screw connections, pin connections, rivet connections, snap-fit connections, welding, or any other desired connection method.

As shown in FIG. 5, in this embodiment, the grip 5000 is made of an elastic material, with one end of the grip 5000 curled inward to form a clasp part 5001; slots 5002 are formed between the metal clip 4000 and both the first connector 2000 and the second connector 3000, and the clasp part 5001 is fitted into the slots 5002.

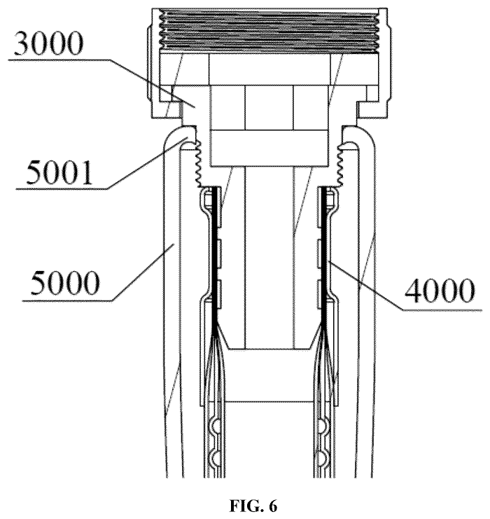

As shown in FIG. 6, in some embodiments, the clasp part 5001 is clamped onto the second connector 3000; similarly (not shown), the clasp part 5001 is clamped onto the first connector 2000.

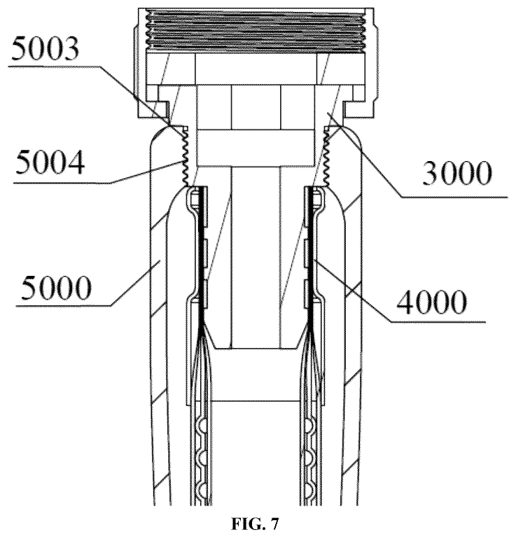

As shown in FIG. 7, in other embodiments, one end of the grip 5000 is provided with an internal thread 5003; both the first connector 2000 and the second connector 3000 are equipped with external threads 5004 for connecting the grip 5000, which are tightly connected with the first connector 2000 and the second connector 3000 by threaded fitting.

Here, the grip 5000 is tightly connected with the first connector 2000 and the second connector 3000 by threaded fitting. In other embodiments (not shown), the grip is not limited to threaded fitting for tight connection with the first and second connectors but can also be designed for threaded connection, pin connection, rivet connection, snap connection, or any other desired connection method.

In this embodiment, the grip 5000 is made of an elastic material, which can be polypropylene random copolymer (PPR), polyethylene (PE), ethylene propylene diene monomer (EPDM), polyurethane (PU), or any other desirable elastic material. In other embodiments (not shown), the grip is not limited to elastic materials and can also be made of non-elastic materials or any other desired material.

As shown in FIGS. 1 to 3, in this embodiment, the first connector 2000 includes a hose body connecting part 2001, an anti-slip part 2002 and an external threaded connecting part 2003 that are sequentially arranged. The hose body connecting part 2001 is used to connect with the hose body 1000, the anti-slip part 2002 prevents slipping during installation, and the external threaded connecting part 2003 serves a connecting function.

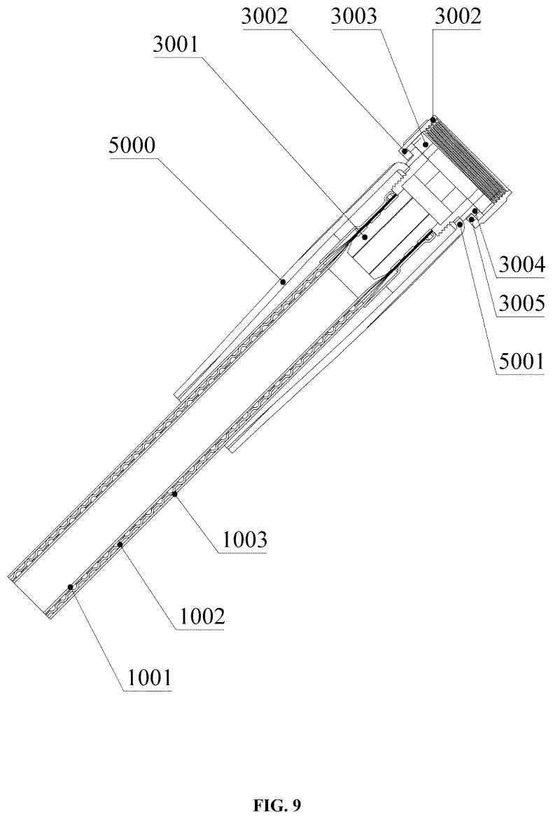

As shown in FIGS. 1 to 9, in this embodiment, the second connector 3000 includes a connection core 3001, an internal threaded sleeve 3002 and a sealing ring 3003, which is elastic. The connection core 3001 is used to connect with the hose body 1000; a first flange 3004 extending outward is provided on the connection core 3001, located at the end away from the hose body 1000. One end of the internal threaded sleeve 3002 is equipped with a second flange 3005, which extends inward. The outer diameter of the first flange 3004 is larger than the inner diameter of the second flange 3005.

In other embodiments, the connection core 3001 is internally provided with a flow hole, the inner diameter of which is 5 mm to 13 mm.

In this embodiment, the connection core 3001 and the internal threaded sleeve 3002 are connected through the first flange 3004 and the second flange 3005. In other embodiments, the connection between the connection core 3001 and the internal threaded sleeve 3002 is not limited to the first flange 3004 and the second flange 3005; it can also be formed as an integrated structure, snap-fit connection, welding, screw connection, pin connection, rivet connection, or any other desired connection method.

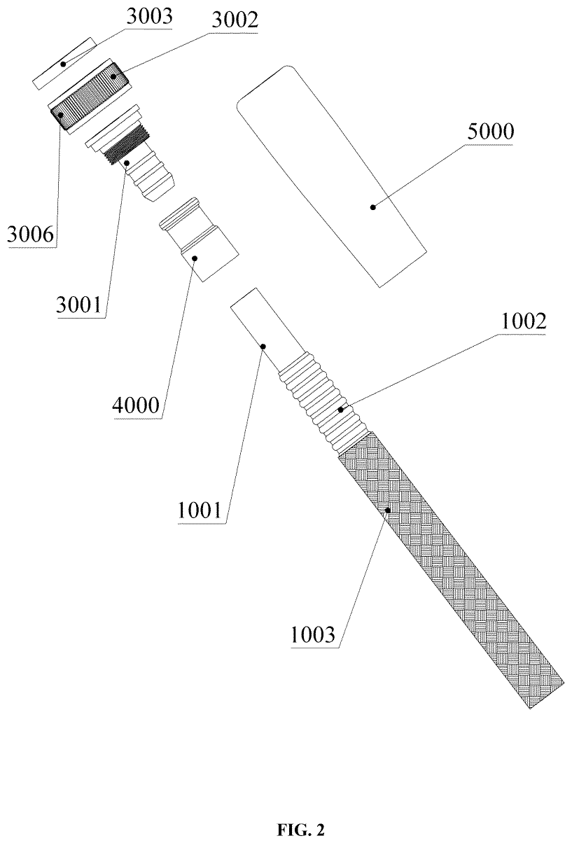

As shown in FIG. 2, in this embodiment, anti-slip grooves 3006 are provided on the exterior of the internal threaded sleeve 3002, extending along the axial direction; the anti-slip grooves 3006 are arranged in an array around the outer circumference of the internal threaded sleeve 3002. In other embodiments (not shown), the anti-slip grooves are not limited to the above shape and can also be designed as circular, polygonal, elliptical, or any other geometric shape that serves an anti-slip function. The material can be metal or plastic.

As shown in FIG. 2, in this embodiment, the sealing ring 3003 is made of rubber or silicone. The outer diameter of the sealing ring 3003 is larger than the inner diameter of the internal threaded sleeve 3002. When the sealing ring 3003 is installed into the internal threaded sleeve 3002, it can limit the position of the internal threaded sleeve 3002. The sealing ring 3003 can be made of nitrile rubber, hydrogenated nitrile rubber, silicone rubber, fluorosilicone rubber, EPDM rubber, neoprene rubber, butyl rubber, acrylic rubber, natural rubber, polyurethane rubber, metal rubber, or any other desired materials.

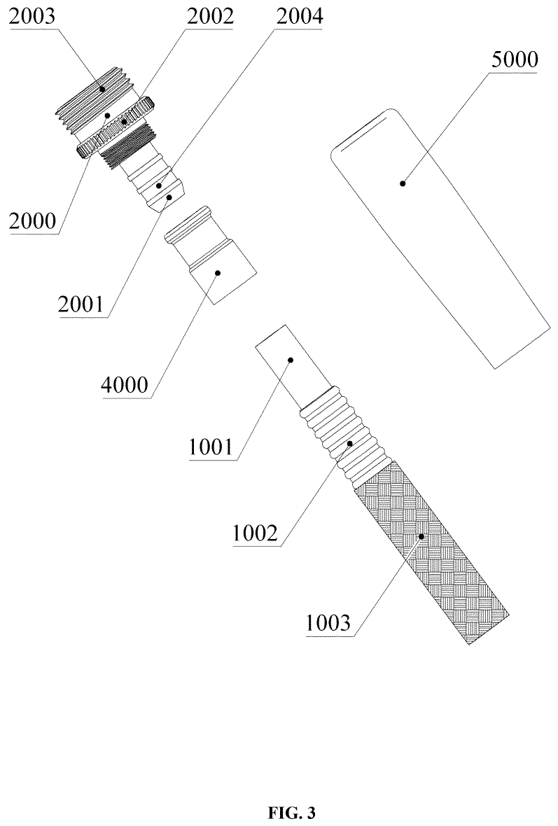

As shown in FIG. 3, in this embodiment, one or more first slots 2004 are provided on the hose body connecting part 2001 to increase friction; the first slots 2004 encircle the hose body connecting part 2001. A chamfer is also provided on the hose body connecting part 2001, located at the end away from the anti-slip part 2002. Additionally, one or more first slots 2004 are also provided on the connection core 3001.

In other embodiments, the hose body connecting part 2001 is not limited to increasing friction by providing first slots 2004; other structures can be used to increase friction, or other methods can be employed to connect the first connector 2000 and the hose body 1000.

In this embodiment, the first tubular component 1001 is made of rubber or plastic; the second tubular component 1002 is made of plastic; when water flow pressure increases, the first tubular component 1001 will undergo a certain degree of radial expansion, which will be limited by the maximum diameter of the non-elastic second tubular component 1002. Here, the first tubular component 1001 is not limited to radial expansion and may also experience axial expansion.

In this embodiment, the material of the first tubular component 1001 is PVC, but it is not limited to PVC and can also be any desirable material such as PPR, TPU, PE, or rubber.

In this embodiment, the material of the second tubular component 1002 is PVC, but it is not limited to PVC and can also be any desirable material such as PPR or PE.

In other embodiments, the outer diameter of the second tubular component 1002 is higher than 13 mm and lower than 25 mm; in some embodiments, the outer diameter of the second tubular component 1002 ranges from 10 mm to 13 mm, 13 mm to 18 mm, 18mmto 20 mm, or 10 mm to 20 mm. Among these, in a 5000-cycle 2.5 MPa pressure test, it was found that the hose body of this design, within 20 mm (actually 13 mm to 18 mm), has a reduced probability of deformation or rupture by 35% compared to diameters larger than 20 mm. In a 1000-cycle 200 KN tensile test, hose bodies with an outer diameter controlled within 20 mm showed a 20% lower probability of damage compared to sizes exceeding 20 mm. Moreover, when the diameter is 14-19 mm, it passes a 10,000-cycle Martindale abrasion test, whereas diameters at 25 mm fail the test. In a 0.45MPa water flow test, inner diameters below 10 mm fail to achieve a 0.3 MPa water flow capacity, while inner diameters above 18 mm show no significant increase in flow rate.

In this embodiment, the third tubular component 1003 is woven from fabric material and cannot expand radially; the thickness of the third tubular component 1003 ranges from 0.3 mm to 0.8 mm, or 0.2 mm to 1 mm. In some embodiments, the thickness of the third tubular component 1003 is not limited to 0.3 mm to 0.8 mm and can also be set to 0.1 mm to 0.6 mm, 0.5 mm to 1.2 mm, 0.8 mm to 1.5 mm or any other desired thicknesses.

In this embodiment, the entire hose can maintain normal water flow without rupture-induced leakage or seepage within a temperature range from a low temperature of −10° to a high temperature of 60°.

In this embodiment, the grip 5000 is made of plastic, with a thickness ranging from 1 mm to 10 mm, and a length from 20 mm to 200 mm.

In other embodiments, the thickness of the grip 5000 is not limited to 1 mm to 10 mm, nor is the length limited to 20 mm to 200 mm; it can also be set to any desired thicknesses and lengths.

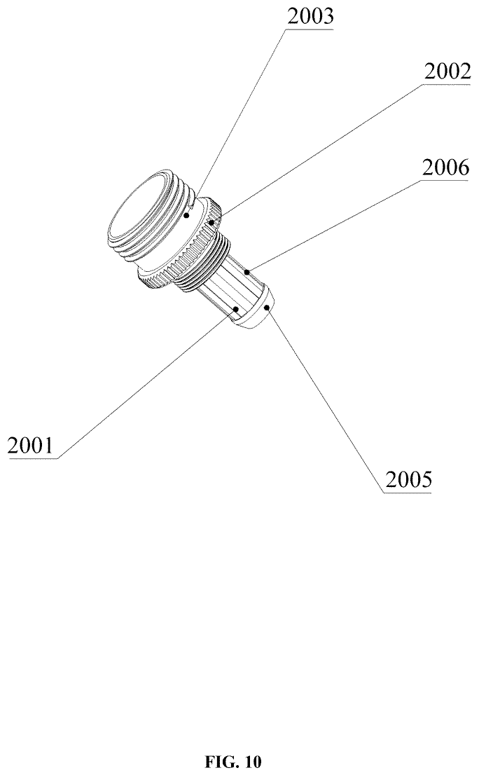

As shown in FIG. 10, in another embodiment, the hose body connecting part 2001 is provided with an insertion part 2005, which is located at the end away from the anti-slip part 2002. The outer diameter of the insertion part 2005 is larger than that of the hose body connecting part 2001, and the insertion part 2005 features a chamfer. Additionally, two or more second slots 2006 are axially arranged on the surface of the hose body connecting part 2001 to increase friction, with the second slots 2006 evenly distributed on the surface.

In other embodiments, increasing friction on the hose body connecting part 2001 is not limited to the use of second slots 2006; other structures can also be employed to enhance friction, or alternative methods can be used to connect the first connector 2000 and the hose body 1000.

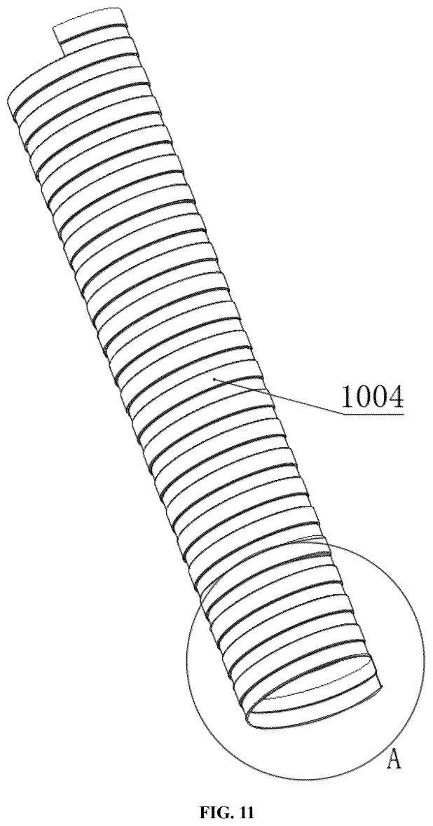

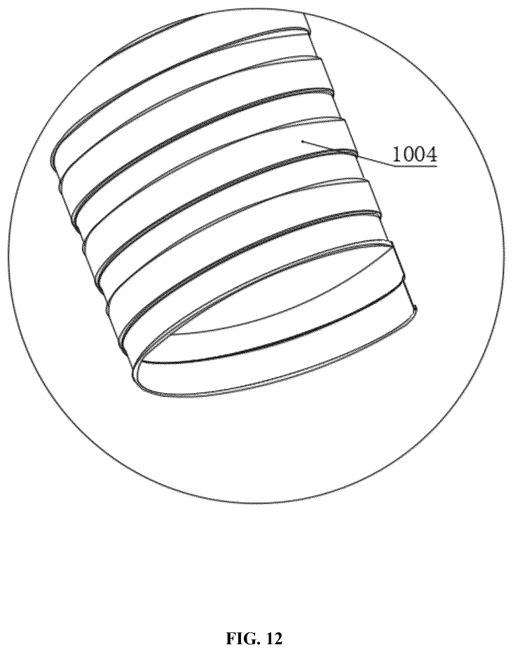

As shown in FIGS. 11 and 12, another embodiment provided by the present disclosure differs from the aforementioned embodiments in that the second tubular component is a spiral tube 1004, made of metal. In this embodiment, the spiral tube 1004 is preferably stainless steel.

In other embodiments, the spiral tube 1004 is not limited to being made of stainless steel and can also be made of any desired material such as copper or aluminum-plastic composite pipe. In other embodiments, the second tubular component is not limited to a spiral tube and can also be configured as a round tube, square tube, rectangular tube, elliptical tube, or any other desired geometric shape.

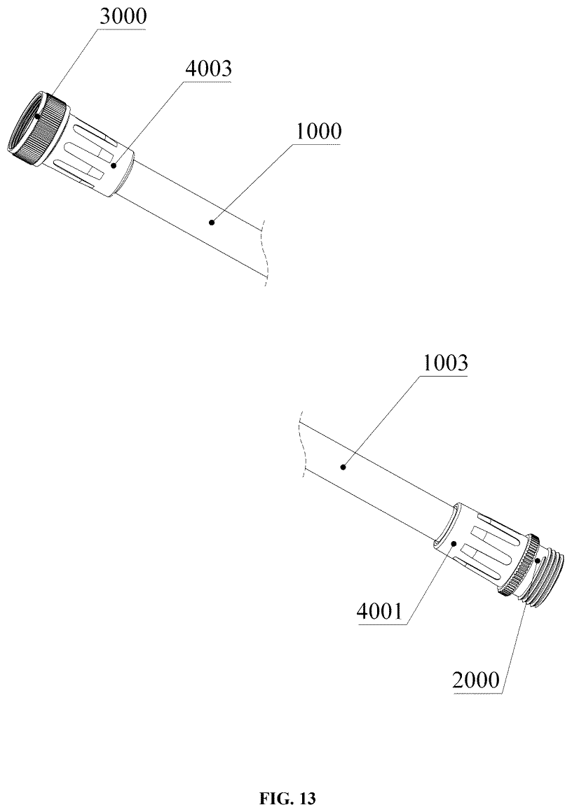

As shown in FIGS. 13 to 16, another embodiment provided by the present disclosure is illustrated. The difference between this embodiment and the aforementioned embodiments lies in: the first connector 2000 is located at one end of the hose body 1000, the second connector 3000 is located at the other end of the hose body 1000, and both ends of the hose body 1000 are tightly connected to the first connector 2000 and the second connector 3000 through locking assemblies 4001 respectively.

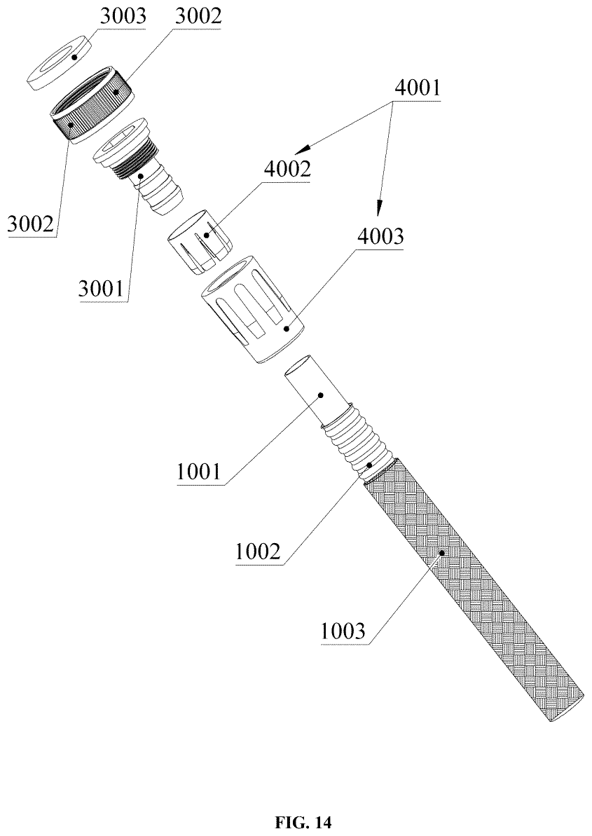

As shown in FIGS. 13 to 14, in this embodiment, the locking assembly 4001 includes an internal retaining ring 4002 and an external sleeve 4003. Here, the internal retaining ring 4002 is sleeved over the third tubular component 1003, and the external sleeve 4003 is sleeved over the internal retaining ring 4002 and the third tubular component 1003, forming a connection with the first connector 2000.

In this embodiment, the internal retaining ring 4002 and the external sleeve 4003 are made of metal materials. In other embodiments, the internal retaining ring and external sleeve are not limited to metal materials and can also be made of plastic, silicone, or any other desired material.

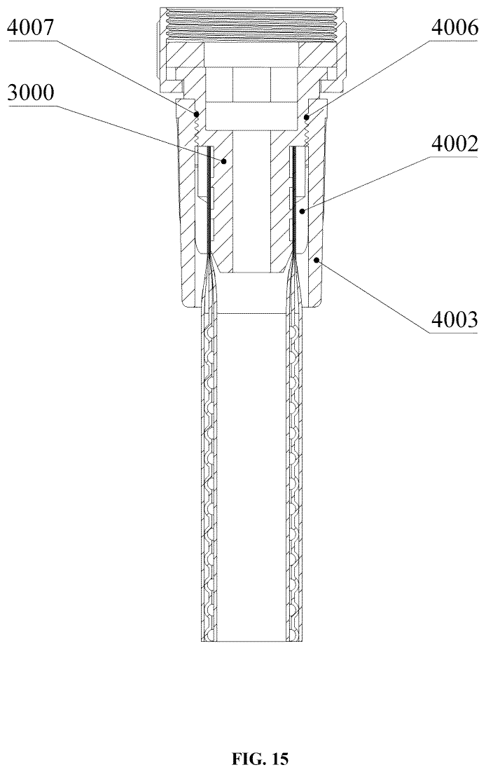

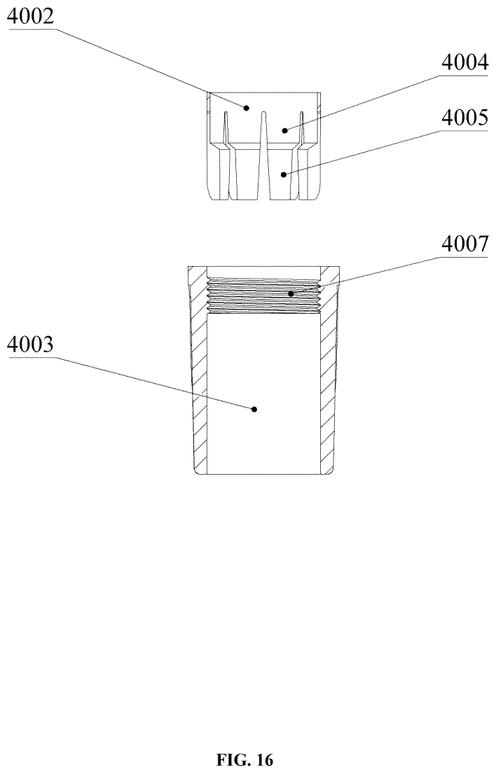

As shown in FIGS. 15 to 16, in this embodiment, the minimum inner diameter of the external sleeve 4003 is smaller than the maximum outer diameter of the internal retaining ring 4002.

In this embodiment, both the first connector and the second connector 3000 are provided with a first threaded part 4006, and the external sleeve 4003 is equipped with a second threaded part 4007 corresponding to the first threaded part 4006. The internal retaining ring 4002 includes compressing parts 4004, which are roughly arc-shaped and arrayed on the internal retaining ring 4002, with compressing blocks 4005 arranged on the compressing parts 4004. When the external sleeve 4003 is connected to the first connector 2000 or the second connector 3000, it drives the internal retaining ring 4002 to compress the hose body 1000, increasing the friction between the hose body 1000 and the first or second connector.

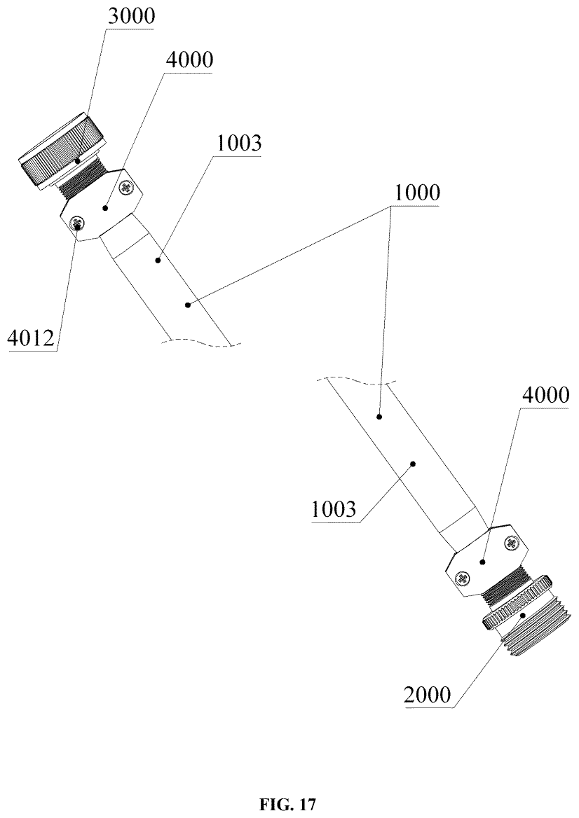

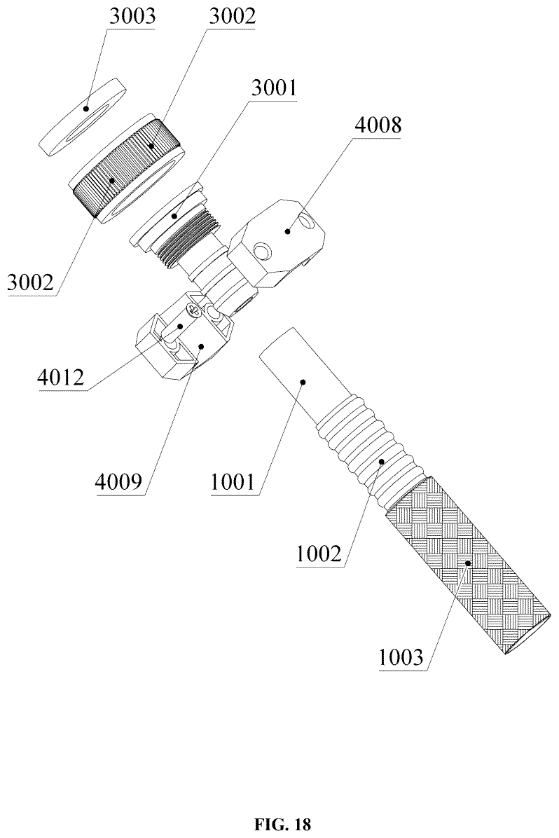

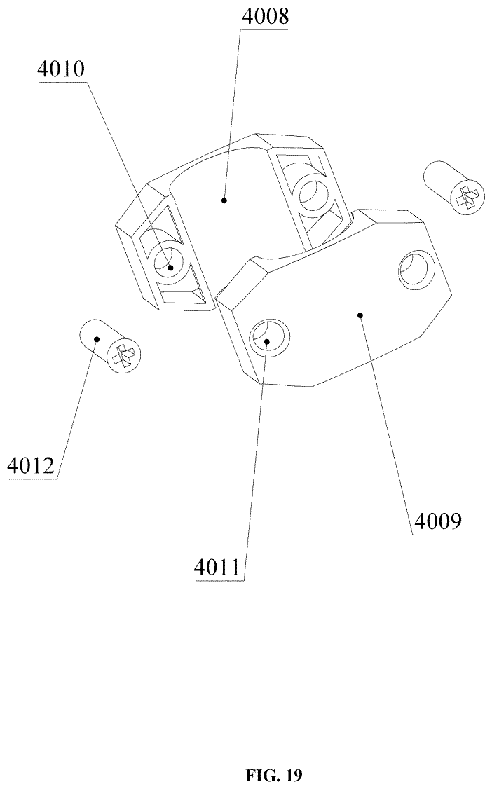

As shown in FIGS. 17 to 19, in another embodiment, the locking assembly includes a first fixing block, a second fixing block and a fastener, with the first fixing block 4008 and the second fixing block 4009 sleeved over the third tubular component 1003.

Here, the first fixing block 4008 is provided with at least one first fixing hole 4010, and the second fixing block 4009 is provided with at least one second fixing hole 4011 corresponding to the first fixing hole 4010. The first fixing block 4008 and the second fixing block 4009 are fixedly connected via the fastener 4012.

In this embodiment, the first fixing block 4008 and the second fixing block 4009 are fixedly connected by a fastener 4012. In other embodiments (not shown), the first fixing block and the second fixing block are not limited to being fixedly connected by a fastener; they can also be designed as snap-fit connections, welded connections, hook-and-loop connections, or any other connection method that meets the desired requirements.

The present disclosure also provides a process for producing a composite garden hose, which includes the following steps:

Step 1: preparing an elastic material for making the first tubular component and a first extruder; preparing a non-elastic material for making the second tubular component and a second extruder; preparing a fabric material for making the third tubular component and a braiding machine; preparing molds and a punch press for stamping; arranging the first extruder, the second extruder and the braiding machine in sequence;

Step 2: preparing grips, metal clips, a first connector and a second connector;

Step 3: starting the machines, introducing a first tubular component extruded by the first extruder into the second extruder, where the second extruder extrudes a second tubular component to cover the first tubular component; introducing the first tubular component and the second tubular component into the braiding machine, where a third tubular component is braided to cover the second tubular component, forming a continuous hose body;

Step 4: cutting the continuous hose body into the required lengths;

Step 5: sleeving two grips onto the cut hose body;

Step 6: sleeving a metal clip onto each end of the hose body;

Step 7: inserting the first connector and the second connector into the two ends of the hose body respectively; and

Step 8: using the molds and punch press to compress and tighten the metal clips, ensuring the metal clip, one end of the hose body, and the first connector are tightly connected; similarly, ensuring the metal clip, the other end of the hose body, and the second connector are tightly connected; and

Step 9: pushing one grip to a position between the metal clip and the first connector; pushing the other grip to a position between the metal clip and the second connector.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A composite garden hose, comprising:
a hose body;
wherein the hose body comprises:
a first tubular component for conveying a liquid; and
a second tubular component continuously formed around the first tubular component to limit expansion of the first tubular component;
wherein an outer diameter of the second tubular component is higher than 13 mm and lower than 18 mm; and
a third tubular component continuously formed around the second tubular component to protect the first tubular component and the second tubular component;
wherein an overall thickness of the third tubular component ranges from 0.2 mm to 1 mm.

2. The composite garden hose according to claim 1, wherein the first tubular component is made of an elastic material; and
the elastic material primarily consists of PVC, PE, PP, PEX, PU, nylon or rubber materials individually or a combination of two or more of the aforementioned materials.

3. The composite garden hose according to claim 1, wherein the second tubular component is made of a plastic or rubber material, has a corrugated structure, and is a corrugated tube as a whole; and
the plastic or rubber material primarily consists of PP, PE, or PVC materials individually or a combination of two or more of the aforementioned materials.

4. The composite garden hose according to claim 3, wherein a pitch between center points of two adjacent crests is 1.5 mm to 4 mm.

5. The composite garden hose according to claim 1, wherein the second tubular component is made of PE or a PE composite material.

6. The composite garden hose according to claim 1, wherein the third tubular component is woven from filaments.

7. The composite garden hose according to claim 6, wherein the filaments consist of polyester, spandex, nylon, bamboo fiber and rayon.

8. The composite garden hose according to claim 6, wherein the filaments are polyester or a polyester blend material.

9. The composite garden hose according to claim 6, wherein a spindle count for filament weaving is 32, 48, 72, or 96 spindles.

10. The composite garden hose according to claim 6, wherein the spindle count for filament weaving is 48.

11. The composite garden hose according to claim 1, further comprising connectors installed at both ends of the hose body.

12. The composite garden hose according to claim 11, wherein the connector comprises a connection core, and a flow hole having an inner diameter of 5-13 mm is provided inside the connection core.

13. A composite garden hose, comprising:
a hose body;
wherein the hose body comprises:
a first tubular component, made of any one material from PVC, PE, PP, PEX, PU, nylon or rubber individually, or a combination of two or more of the aforementioned materials; and
a second tubular component, made of PP, PE, or PVC materials, with a hardness of the first tubular component being lower than that of the second tubular component;
wherein the second tubular component has a corrugated structure and is a corrugated tube as a whole; and
a pitch between adjacent crest center points of the second tubular component ranges from 1.5 mm to 4 mm; and
a third tubular component, woven from filaments, with an overall thickness ranging from 0.2 mm to 1 mm;
wherein the filaments consist of polyester, spandex, nylon, bamboo fiber and rayon.

14. The composite garden hose according to claim 13, wherein the second tubular component has a corrugated structure and is a corrugated tube as a whole.

15. The composite garden hose according to claim 14, wherein the pitch between center points of two adjacent crests of the second tubular component is 1.5 mm to 4 mm;

16. The composite garden hose according to claim 13, wherein the second tubular component is made of a PE material or a composite material of PVC, PE and PP.

17. The composite garden hose according to claim 13, wherein the filaments are polyester or a polyester blend material.

18. The composite garden hose according to claim 13, wherein an outer diameter of the second tubular component is 10 mm to 20 mm.

19. The composite garden hose according to claim 13, wherein the outer diameter of the second tubular component is 13 mm to 18 mm.

20. A composite garden hose, comprising:
a hose body;
wherein the hose body comprises:
a second tubular component, made of PP, PE, or PVC materials;
wherein the second tubular component has a corrugated structure and is a corrugated tube as a whole; and
a pitch between center points of two adjacent crests on a surface of the second tubular component is 1.5 mm to 4 mm; and
a third tubular component, woven from filaments, with an overall thickness of 0.2 mm to 1 mm;
wherein the filaments consist of polyester, spandex, nylon, bamboo fiber or rayon.
